(19) United States
(12) Patent Application Publication
(10) Pub. No.: US 2015/0040867 A1
(43) Pub. Date: Feb. 12, 2015

(54) FUEL INJECTOR NEEDLE SLEEVE

(71) Applicant: INTERNATIONAL ENGINE INTELLECTUAL PROPERTY COMPANY, LLC, Lisle, IL (US)

(72) Inventors: Abhijit P. Upadhye, Columbia, SC (US); Joset Morell, Blythewood, SC (US)

(73) Assignee: International Engine Intellectual Property Company, LLC, Lisle, IL (US)

(21) Appl. No.: 14/384,218

(22) PCT Filed: Mar. 18, 2013
(86) PCT No.: PCT/US13/32797

§ 371 Date: Sep. 10, 2014

Related U.S. Application Data
(60) Provisional application No. 61/611,995, filed on Mar. 16, 2012.

(51) Int. Cl. F02M 55/02; F02M 63/00

(52) U.S. Cl. CPC F02M 55/025; F02M 63/0033
USPC 123/456; 239/584

(57) ABSTRACT

A fuel injector for a fuel injection system includes a nozzle body defining a nozzle body chamber, a needle movably received within the nozzle body chamber for movement between a seated position and a raised position, and a needle sleeve at least partially surrounding the needle and at least partially defining a control volume. The needle moves from the seated position to the raised position in response to a pressure differential between the control volume and the nozzle body chamber. When the needle is in the seated position clearance exists between the needle sleeve and the needle thereby permitting fuel flow between the control volume and the nozzle body chamber, and when the needle is in the raised position, the needle sleeve deforms to reduce the clearance and restrict fuel flow between the control volume and the nozzle body chamber.

### CROSS REFERENCE TO RELATED APPLICATION

This application claims the benefit of and priority to U.S. Provisional Patent Application No. 61/611,995, filed Mar. 16, 2012, the entire contents of which are hereby incorporated by reference herein.

### TECHNICAL FIELD

The technical field relates to fuel injectors, and more particularly a fuel injector needle and associated needle control sleeve.

### BACKGROUND

Many fuel injectors operate by controlling movement of a needle in relationship to a needle seat. When the needle is lifted away from the needle seat, an injection event begins. When the needle is re-seated onto the needle seat, the injection event terminates. In some fuel injectors, movement of the needle is controlled by a needle control valve that creates pressure differentials on various surfaces of the needle. Movement of the needle can also be guided or controlled by precisely machined needle guides and/or needle guide bushings. By precisely controlling movement of the needle, designers can improve the accuracy and consistency of fuel injection events, which in turn can improve engine efficiency and the overall quality of engine operation.

### SUMMARY

In some aspects, a fuel injector includes a nozzle body defining a nozzle body chamber, a needle movably received within the nozzle body chamber for movement between a seated position and a raised position, and a needle sleeve at least partially surrounding the needle and at least partially defining a control volume. The needle moves from the seated position to the raised position in response to a pressure differential between the control volume and the nozzle body chamber. When the needle is in the seated position clearance exists between the needle sleeve and the needle thereby permitting fuel flow between the control volume and the nozzle body chamber, and when the needle is in the raised position, the needle sleeve deforms to reduce the clearance and restrict fuel flow between the control volume and the nozzle body chamber.

In other aspects, a fuel injection system includes a fuel rail, a high pressure pump supplying high pressure fuel to the fuel rail, and a fuel injector receiving fuel from the fuel rail. The fuel injector includes a nozzle body defining a nozzle body chamber and a needle having a proximal end. The needle is movably received within the nozzle body chamber for movement between a seated position and a raised position. The fuel injector also includes a needle sleeve at least partially surrounding the proximal end of the needle and at least partially defining a control volume. The needle sleeve and the proximal end of the needle cooperate to define a clearance that permits fuel flow between the control volume and the nozzle body chamber when the needle is between the seated position and the raised position. The system also includes a needle control valve communicating with the control volume and operable to move the needle from the seated position to the raised position by creating a pressure differential between the control volume and the nozzle body chamber. When the needle is in the raised position, the needle sleeve deforms to reduce the clearance and restrict fuel flow between the control volume and the nozzle body chamber.

In still other aspects, a method is provided for controlling movement of a needle between a seated position and a raised position within a nozzle body chamber of a fuel injector. The fuel injector includes a needle sleeve at least partially surrounding the needle and at least partially defining a control volume. The needle sleeve and the needle cooperate to define a clearance that permits fuel flow between the control volume and the nozzle body chamber when the needle is between the seated position and the raised position. The method includes supplying high pressure fuel to the nozzle body chamber and the control volume such that the needle is in the seated position. Pressure is reduced in the control volume to create a first pressure differential between the control volume and the nozzle body chamber sufficient to move the needle from the seated position toward the raised position, and to cause fuel flow through the clearance between the nozzle body chamber and the control volume. When the needle reaches the raised position, pressure in the control volume is further reduced to create a second pressure differential between the control volume and the nozzle body chamber that is higher than the first pressure differential and that is sufficient to deform the needle sleeve. Deformation of the needle sleeve reduces the clearance and restricts fuel flow between the nozzle body chamber and the control volume.

### BRIEF DESCRIPTION OF THE DRAWINGS

FIG. 1 is a schematic diagram of a fuel injection system;

FIG. 2 is a section view of a portion of a fuel injector of the fuel injection system of FIG. 1;

FIG. 3 is an enlarged view of a needle guide portion of the fuel injector of FIG. 2;

FIG. 4 is a further enlarged view of the needle guide portion showing the needle in a seated position;

FIG. 5 is an enlarged view of the needle guide portion similar to FIG. 4 showing the needle in a partially raised position;

FIG. 6 is an enlarged view of the needle guide portion similar to FIGS. 4 and 5 showing the needle in a fully raised position; and,

FIG. 7 is a series of graphs showing needle motion, nozzle body chamber pressure, and control volume pressure versus time for a portion of an injection event.

### DETAILED DESCRIPTION

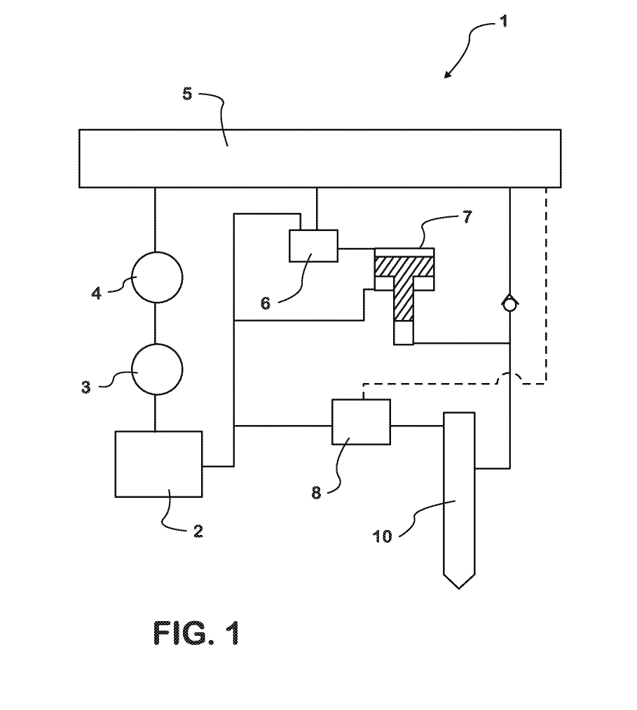

Referring to the Figures, and specifically to FIG. 1, there is shown a fuel injection system 1 including a source of fuel, such as a tank 2, and a low pressure pump 3 pumping fuel from the tank 2 to a high pressure pump 4. The high pressure pump 4 pumps high pressure fuel into a high pressure fuel rail 5. An intensifier control valve 6 controls the delivery of high pressure fuel from the rail 5 to an intensifier 7, and a needle control valve 8 fluidly communicates with a fuel injector 10. As discussed further below, in some embodiments, the needle control valve 8 is operable to establish fluid communication between the fuel injector 10 and the tank 1. In other embodiments, the needle control valve 8 also is operable to establish fluid communication between the fuel injector 10 and the rail 5, as shown by the dashed line of FIG. 1. The fuel injection system 1 of FIG. 1 is one example of a particular fuel injection system with which the fuel injector 10 can be used. Those skilled in the art will readily appreciate that the fuel injector 10 discussed below can be used with fuel injection systems having configurations and arrangements of components different from the exemplary fuel injection system 1 shown in FIG. 1.

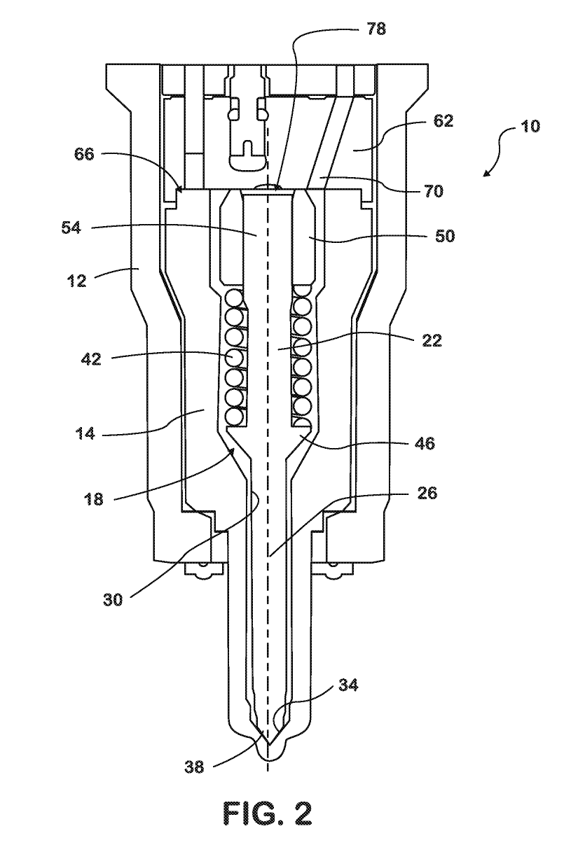

Referring also to FIG. 2, there is shown the internal structure of a portion of one embodiment of one of the fuel injectors 10. In this embodiment, the fuel injector 10 includes a housing 12 and a nozzle body 14 received by and retained within the housing 12. The nozzle body 14 defines a nozzle body chamber 18 that receives a needle 22. The needle 22 is received within the nozzle body chamber 18 for axial movement substantially along an injector axis 26 between a seated position and a fully raised position. A medial portion of the nozzle body 14 defines a needle guide 30 that closely receives the needle 22 and guides movement of the needle 22 along the injector axis 26. A distal portion of the nozzle body 14 defines a needle seat 34 against which a tip 38 of the needle 22 is seated in between fuel injection events. A needle spring 42 biases the needle 22 toward the needle seat 34. The needle spring 42 surrounds a portion of the needle 22 and is captured between a flanged portion 46 of the needle 22 and a needle sleeve 50 that receives and at least partially surrounds a proximal end 54 of the needle 22. It should be understood that the needle sleeve 50 may fully or partially surround the needle 22, and may be formed of one piece or a plurality of pieces that are connected, joined, or otherwise coupled together. During an injection event the needle 22 moves proximally, away from the seated position, such that the tip 38 lifts away from the needle seat 34, thereby allowing fuel to flow past the needle seat 34 for injection into the engine combustion chamber with which the fuel injector 10 is associated.

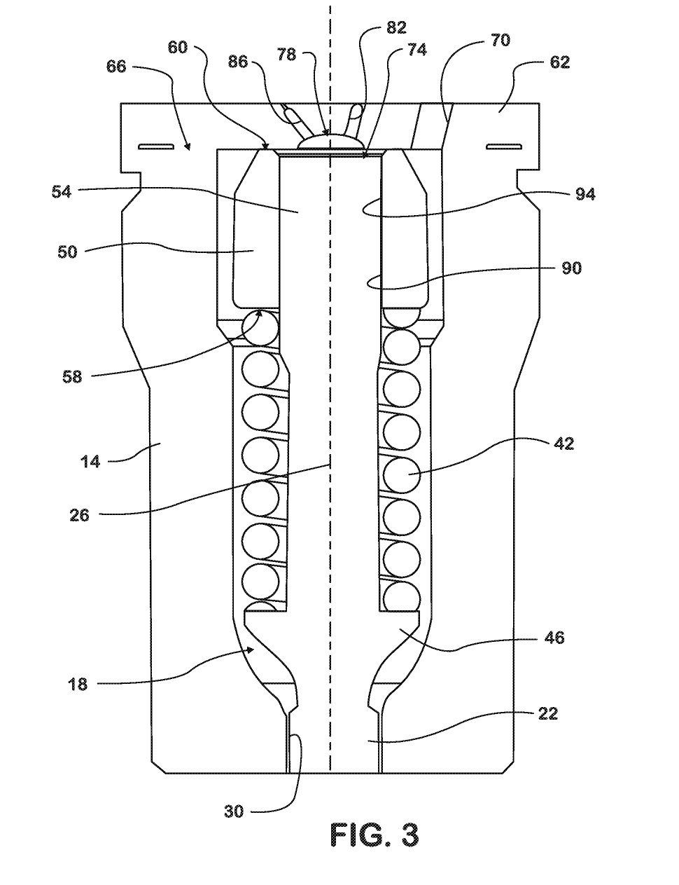

Referring also to FIG. 3, which illustrates a proximal portion of the nozzle body 14, in one embodiment the needle sleeve 50 is generally cylindrical and includes a distal annular surface 58 that engages the needle spring 42, and a proximal annular surface 60 that engages an orifice plate 62. The orifice plate 62 is sealingly coupled to an end surface 66 of the nozzle body 14, and defines an injection inlet 70 that communicates with the nozzle body chamber 18. The orifice plate 62 also cooperates with the needle sleeve 50 and an end surface 74 of the needle 22 to define a control chamber or control volume 78. During operation, both the nozzle body chamber 18 and the control volume 78 are filled with fuel. As discussed further below, pressure differentials between the fuel contained in the nozzle body chamber 18 and the fuel contained in the control volume 78 cause axial movement of the needle 22 during an injection event. In this regard, the orifice plate 62 also defines a control inlet 82 communicating with the control volume 78, and a control outlet 86 also communicating with the control volume 78. At least the control outlet 86, and in some embodiments also the control inlet 82, communicates with the needle control valve 8 (FIG. 1) and can be opened and closed by the needle control valve 8 to regulate flow into and out of the control volume 78. In some embodiments, the control inlet 82 is always opened to a source of high pressure fuel. In other embodiments the control inlet 82 may be controllable between an on condition and an off condition. The control inlet 82 and the control outlet 86 both can include control orifices optimized to provide desired inlet and outlet flow characteristics for the flow of fuel into and out of the control volume 78.

In the illustrated embodiment, when the pressure of fuel in the control volume 78 is substantially equal to the pressure of fuel in the nozzle body chamber 18, the needle 22 is biased toward the distal end of the nozzle body 14 such that the needle tip 38 is seated against the needle seat 34, thereby substantially preventing the flow of fuel past the needle seat 34. When the needle control valve 8 operates to reduce the pressure of fuel in the control volume 78 relative to the pressure of fuel in the nozzle body chamber 18, the resulting pressure differential causes the needle 22 to move in the proximal direction, thereby lifting the needle tip 38 away from the needle seat 34 and initiating an injection event. The injection event continues until the needle control valve 8 operates to increase the pressure in the control volume 78 to once again be substantially equal to the pressure in the nozzle body chamber 18. The increasing pressure in the control volume 78 applies an increasing force to the end surface 74 of the needle 22, which force urges the needle 22 in the distal direction to seat the needle tip 38 against the needle seat 34. In the illustrated embodiment, the changes in fuel pressure within the control volume 78 are regulated by a combination of the needle control valve 8 and the control orifices provided in the control inlet 82 and the control outlet 86 of the orifice plate 62.

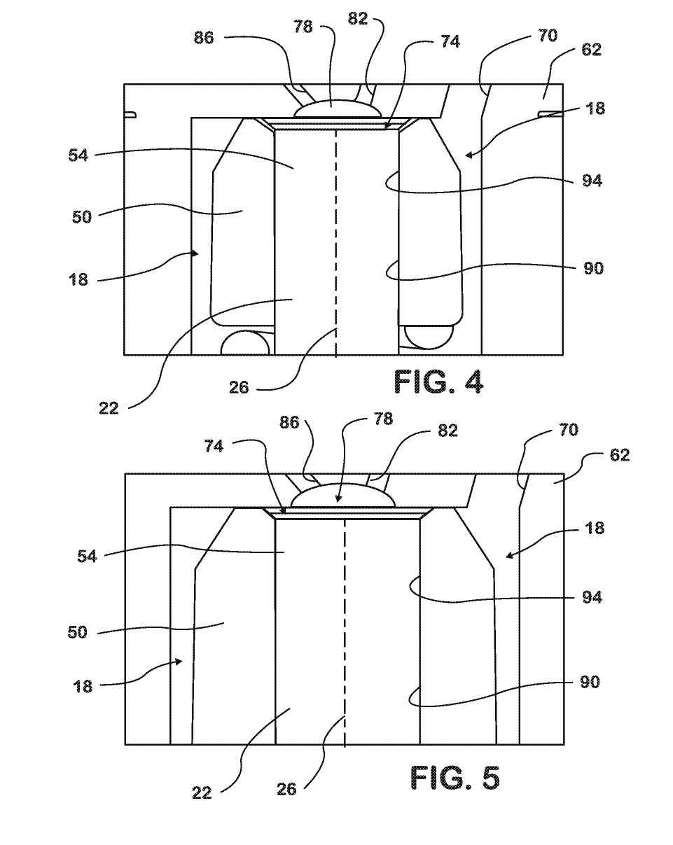

Referring also to FIGS. 4 through 6, in the illustrated embodiment, the interior of the needle sleeve 50 includes a first portion 90 having a relatively closely matched size with respect to the proximal end 54 of the needle 22, and a second portion 94 having a relatively loosely matched size with respect to the proximal end 54 of the needle 22. In one exemplary and non-limiting embodiment, the first portion 90 has an internal radius of about 1.7515 mm, and the second portion 94 has an internal radius of about 1.77 mm. The size or dimension of the first portion 90 and the second portion 94 are such that when the pressure differential between the control volume 78 and the nozzle body chamber 18 is relatively low, a small amount of fuel flow is permitted due to clearance between the first portion 90 and the proximal end 54 of the needle 22. In general, fuel flow occurs at the very beginning and the very end of an injection event while the needle 22 is moving from the seated position to the fully raised position. Because pressure in the control volume 78 is generally either substantially equal to or less than the pressure in the nozzle body chamber 18, fuel generally flows from the nozzle body chamber 18, through the clearance between the needle sleeve 50 and the proximal end 54 of the needle 22, and into the control volume 78.

The overall construction of the needle sleeve 50 and its size and clearance with respect to the proximal end 54 of the needle 22 creates a dynamic seal that is active to substantially seal the control volume 78 from the nozzle body chamber 18 when the needle 22 is in the fully raised position. Features of the needle sleeve 50 that contribute to its function as a dynamic seal may include, for example, the inner diameters of the first portion 90 and the second portion 94, and the material, length, outer diameter, and wall thickness of the needle sleeve 50. The needle sleeve 50 is configured such that when the pressure differential between the control volume 78 and the nozzle body chamber 18 is relatively high, the needle sleeve 50 deforms and squeezes down upon the proximal end 54 of the needle 22. As a result, the clearance between the first portion 90 and the proximal end 54 of the needle 22 is reduced and may be substantially eliminated. When the clearance between the first portion 90 and the proximal end 54 of the needle 22 is reduced or substantially eliminated, flow of fuel from the nozzle body chamber 18 to the control volume 78 is restricted and may be substantially eliminated. In this regard, deformation of the needle sleeve 50 when the needle 22 is in the raised position can substantially seal the control volume 78 from the nozzle body chamber 18. Moreover, when the needle sleeve 50 deforms it squeezes down upon the proximal end of the needle 22, which restricts substantial axial movement of the needle 22. Deformation of the needle sleeve 50 and the corresponding reduction or elimination of fuel flow between the control volume 78 and the nozzle body chamber 18, as well as the restriction of substantial movement of the needle 22, both generally occur after the needle 22 has moved to the fully raised position and while the injection event is ongoing. As a result, the dynamic seal aspect of the needle sleeve 50 is generally inactive when the needle 22 is in a position other than the fully raised position, and becomes active to substantially seal the control volume 78 from the nozzle body chamber 18 when the needle 22 is in the fully raised position.

Turning specifically to FIG. 4, the needle 22 is shown in its down or seated position. In FIG. 4 the pressure in the control volume 78 is substantially equal to the pressure in the nozzle body chamber 18, both of which are maintained at a relatively high value. Because there is substantially no pressure differential between the control volume 78 and the nozzle body chamber 18, there is substantially no fuel flow between the needle sleeve 50 and the needle 22, the needle sleeve 50 maintains its shape, and the clearance between the first portion 90 and the proximal end 54 of the needle 22 remains substantially unchanged.

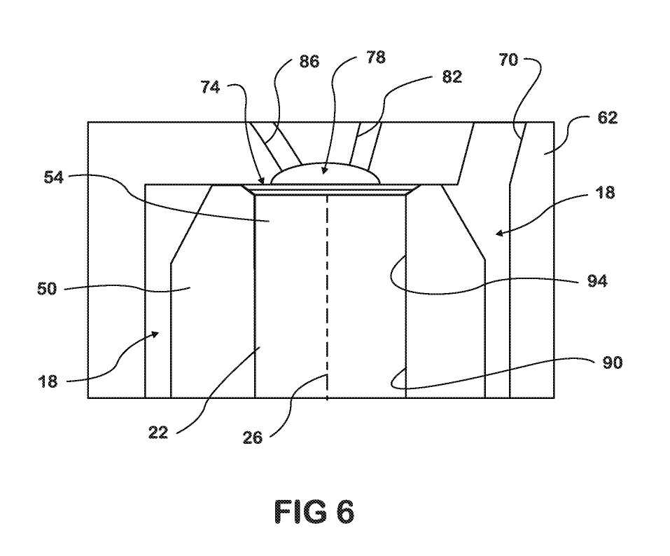

Turning now to FIG. 5, the needle 22 is shown in a partially raised position associated with the initiation or termination of an injection event. Because of such movement, in FIG. 5 the needle 22 is shown as positioned between the seated position shown in FIG. 4 and the fully raised position shown in FIG. 6. In FIG. 5, the pressure in the nozzle body chamber 18 is at a relatively high value, and the pressure in the control volume 78 is slightly less than the pressure in the nozzle body chamber 18. As a result, there is a relatively low pressure differential between the nozzle body chamber 18 and the control volume 78. The relatively low pressure differential is sufficient to cause fuel to flow through the clearance between the first portion 90 and the proximal end 54 of the needle 22, but is insufficient to cause the needle sleeve 50 to deform in a manner that would eliminate the clearance between the first portion 90 of the needle sleeve 50 and the proximal end 54 of the needle 22. Because clearance between the needle sleeve 50 and the needle 22 is maintained, the needle 22 can continue its axial movement between the seated position and the fully raised position without the needle sleeve 50 binding on the needle sleeve 50.

Turning now to FIG. 6, the needle 22 is shown in the fully raised position associated with an ongoing injection event. In FIG. 6, the pressure in the nozzle body chamber 18 is at a relatively high value, and the pressure in the control volume 78 is significantly less than the pressure in the nozzle body chamber 18. As a result, there is a relatively high pressure differential between the nozzle body chamber 18 and the control volume 78. The relatively high pressure on the outside of the needle sleeve 50 and the relatively low pressure on the inside of the control volume 78 activates the dynamic seal aspect of the needle sleeve 50 and causes the needle sleeve 50 to deform radially inwardly toward the proximal end 54 of the needle 22. The deformation of the needle sleeve 50 is such that the clearance between the first portion 90 of the needle sleeve 50 and the proximal end 54 of the needle 22 is reduced and may be substantially eliminated, thereby restricting and in some cases substantially eliminating the flow of fuel from the nozzle body chamber 18 into the control volume 78. Deformation of the needle sleeve 50 may also squeeze down upon the proximal end 54 of the needle 22 to restrict substantial axial movement of the needle 22 while the injection event is proceeding. When the injection event is completed, the needle control valve 8 operates to increase pressure in the control volume 78. As a result, the pressure differential between the nozzle body chamber 18 and the control volume 78 is reduced, the needle sleeve 50 radially expands toward its nominal or undeformed geometry, and the clearance between the needle sleeve 50 and the proximal end 54 of the needle 22 is restored, thereby deactivating the dynamic seal aspect of the needle sleeve 50. With the clearance between the first portion 90 and the proximal end 54 restored, the needle 22 is allowed to move toward the seated position shown in FIG. 4, and flow of fuel between the nozzle body chamber 18 and the control volume 78 is again permitted by way of the clearance.

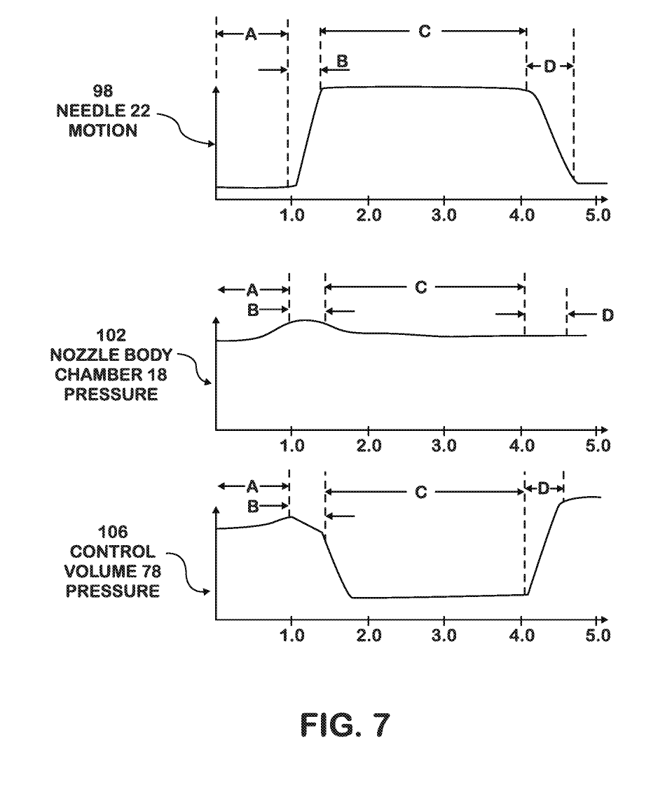

Referring also to FIG. 7, three graphs illustrate needle motion, nozzle body chamber pressure, and control volume pressure for a single injection event. The graphs include a first graph 98 showing motion of the needle 22 versus time, a second graph 102 showing pressure in the nozzle body chamber 18 versus time, and a third graph 106 showing pressure in the control volume 78 versus time. At the top of FIG. 7 the graphs 98, 102, and 106 are divided into a first region A corresponding to a time period before the initiation of an injection event when the needle 22 is in the seated position, a second region B corresponding to a time period during which the needle 22 is moving from the seated position to the fully raised position, a third region C corresponding to a time period during the injection event when the needle 22 is in the fully raised position, and a fourth region D corresponding to a time period during which the needle 22 is moving from the fully raised position back toward the seated position.

Region A substantially corresponds to the needle 22 position shown in FIG. 4 and the related description. As shown, needle 22 is in the seated position (graph 98) and high pressure fuel is supplied to the nozzle body chamber 18 and the control volume 78 such that fuel pressure in the nozzle body chamber 18 (graph 102) is substantially the same as the pressure in the control volume 78 (graph 106). Before initiation of an injection event, the intensifier control valve 6 and intensifier 7 (FIG. 1) operate to increase pressure in the nozzle body chamber 18 and in the control volume 78 at substantially the same rate, such that the two pressures remain substantially equal to one another and the needle 22 remains in the seated position. During operation in region A, the control volume pressure is high, the nozzle body chamber pressure is high, there is substantially no fuel leakage between the needle sleeve 50 and the needle 22 (because there is substantially no pressure differential), and the needle sleeve 50 is not deformed such that the needle 22 is otherwise free to move axially within the needle sleeve 50.

At the start of region B, the needle control valve 8 has operated to open the control outlet 86 and thereby reduce pressure in the control volume 78 (graph 106). As the pressure in the control volume 78 drops, a first pressure differential is created between the control volume 78 and the nozzle body chamber 18 such that the needle 22 begins to rise (graph 98) and moves from the seated position of FIG. 4 toward the raised position of FIG. 6 by moving through the position shown in FIG. 5. As the needle 22 rises, the volume of the control volume decreases and the corresponding pressure in the control volume 78 begins to decline. There may also be a very slight drop in pressure within the nozzle body chamber 18, but the pressure in the nozzle body chamber 18 nonetheless remains slightly higher than the pressure in the control volume 78. This relatively low first pressure differential is insufficient to deform the needle sleeve 50, and causes fuel to flow from the nozzle body chamber 18 into the control volume 78 by way of the clearance between the needle sleeve 50 and the needle 22. During operation in region B, the control volume pressure is medium, the nozzle body chamber pressure is high, there is fuel flow through the clearance between the needle sleeve 50 and the needle 22, and the needle sleeve 50 is not deformed such that the needle 22 remains free to move axially within the needle sleeve.

At the start of region C, the needle 22 reaches the fully raised position (graph 98) corresponding to the position shown in FIG. 6. When the needle 22 reaches the fully raised position, the volume of the control volume 78 can no longer decrease and pressure in the control volume 78 drops significantly and at a faster rate than when the needle 22 is moving (graph 106). Other than some modest initial fluctuations before reaching equilibrium, pressure in the nozzle body chamber 18 remains relatively constant (graph 102). As a result, a second pressure differential is developed between the control volume 78 and the nozzle body chamber 18 that is greater than the first pressure differential discussed above and associated with region B. The larger second pressure differential is sufficient to deform the needle sleeve 50, which compresses radially around the needle 22 to restrict or substantially prevent the flow of fuel from the nozzle body chamber 18 to the control volume 78. Deformation of the needle sleeve 50 may also restrict substantial movement of the needle 22 away from the raised position. During operation in region C, the control volume pressure is low, the nozzle body chamber pressure is high, and the needle sleeve 50 is deformed by the high pressure differential such that the flow of fuel from the nozzle body chamber 18 to the control volume 78 is restricted or substantially prevented. Deformation of the needle sleeve 50 may also prevent substantial movement of the needle 22.

The system remains in substantial equilibrium until the end of region C and the beginning of region D, which is associated with initiation of termination of the injection event. To terminate the injection event, the needle control valve 8 closes the control outlet 86 such that pressure in the control volume 78 begins to increase (graph 106). As pressure in the control volume 78 increases, pressure in the nozzle body chamber 18 remains substantially the same, thereby decreasing the pressure differential between the control volume 78 and the nozzle body chamber 18. The reduced pressure differential allows the needle sleeve 50 to expand, generally radially outwardly, back toward its undeformed configuration, thereby reestablishing the clearance between the needle sleeve 50 and the needle 22 and allowing the needle 22 to move back toward the seated position under the influence of the needle spring 42. When pressure in the control volume 78 is again equal to pressure in the nozzle body chamber 18, the needle 22 is returned to the seated position and will remain there until the next injection event.

What is claimed is:

1. A fuel injector comprising:
a nozzle body defining a nozzle body chamber;
a needle movably received within the nozzle body chamber for movement between a seated position and a raised position; and
a needle sleeve at least partially surrounding the needle and at least partially defining a control volume, wherein the needle moves from the seated position to the raised position in response to a pressure differential between the control volume and the nozzle body chamber, wherein when the needle is in the seated position clearance exists between the needle sleeve and the needle thereby permitting fuel flow between the control volume and the nozzle body chamber, and wherein when the needle is in the raised position, the needle sleeve deforms to reduce the clearance and restrict fuel flow between the control volume and the nozzle body chamber.

2. The fuel injector of claim 1, wherein the needle sleeve deforms in response to the pressure differential between the control volume and the nozzle body chamber.

3. The fuel injector of claim 1, wherein the needle sleeve is substantially annular and deforms in a generally radially inward direction.

4. The fuel injector of claim 1, wherein the needle sleeve is substantially annular and includes a first portion having a first inner diameter and a second portion having a second inner diameter larger than the first inner diameter.

5. The fuel injector of claim 4, wherein the clearance is defined between the first portion of the needle sleeve and a proximal end of the needle.

6. The fuel injector of claim 1, wherein when the needle is positioned between the seated position and the raised position, the clearance remains and permits fuel flow between the control volume and the nozzle body chamber.

7. The fuel injector of claim 6, wherein when the needle is in the raised position, the needle sleeve deforms to substantially eliminate the clearance and to substantially seal the control volume from the nozzle body chamber.

8. A fuel injection system comprising:
a fuel rail;
a high pressure pump supplying high pressure fuel to the fuel rail;
a fuel injector receiving fuel from the fuel rail, the fuel injector including
a nozzle body defining a nozzle body chamber,
a needle having a proximal end, the needle movably received within the nozzle body chamber for movement between a seated position and a raised position, and
a needle sleeve at least partially surrounding the proximal end of the needle and at least partially defining a control volume, the needle sleeve and the proximal end of the needle cooperating to define a clearance that permits fuel flow between the control volume and the nozzle body chamber when the needle is between the seated position and the raised position; and
a needle control valve communicating with the control volume and operable to move the needle from the seated position to the raised position by creating a pressure differential between the control volume and the nozzle body chamber, wherein when the needle is in the raised position, the needle sleeve deforms to reduce the clearance and restrict fuel flow between the control volume and the nozzle body chamber.

9. The fuel injection system of claim 8, wherein the needle sleeve deforms in a generally radially inward direction and squeezes down upon the proximal end of the needle.

10. The fuel injection system of claim 8, wherein when the needle is positioned between the seated position and the raised position, a clearance defined between the needle sleeve and the proximal end of the needle permits leakage between the control volume and the nozzle body chamber.

11. The fuel injection system of claim 8, wherein when the needle is in the raised position, the needle sleeve deforms to substantially eliminate the clearance and to substantially seal the control volume from the nozzle body chamber.

12. The fuel injection system of claim 8, wherein the needle control valve is operable to open a control outlet that communicates with the control volume to reduce pressure in the control volume.

13. The fuel injection system of claim 8, wherein the needle sleeve is substantially annular and includes a first portion having a first inner diameter and a second portion having a second inner diameter larger than the first inner diameter, and wherein the clearance is defined between the first portion and the proximal end of the needle.

14. A method for controlling movement of a needle between a seated position and a raised position within a nozzle body chamber of a fuel injector, the fuel injector including a needle sleeve at least partially surrounding the needle and at least partially defining a control volume, the needle sleeve and the needle cooperating to define a clearance that permits fuel flow between the control volume and the nozzle body chamber when the needle is between the seated position and the raised position, the method comprising:
supplying high pressure fuel to the nozzle body chamber and the control volume such that the needle is in the seated position;
reducing pressure in the control volume to create a first pressure differential between the control volume and the nozzle body chamber sufficient to move the needle from the seated position toward the raised position and to cause fuel flow through the clearance between the nozzle body chamber and the control volume; and
when the needle reaches the raised position, further reducing pressure in the control volume to create a second pressure differential between the control volume and the nozzle body chamber that is higher than the first pressure differential and sufficient to deform the needle sleeve, wherein deformation of the needle sleeve reduces the clearance and restricts fuel flow between the nozzle body chamber and the control volume.

15. The method of claim 14, wherein deformation of the needle sleeve includes engaging the needle sleeve with the needle to substantially eliminate the clearance and substantially seal the control volume from the nozzle body chamber.
